(19) United States
(12) Patent Application Publication
(10) Pub. No.: US 2023/0329188 A1
(43) Pub. Date: Oct. 19, 2023

(54) SWING-ARM FOR HEADLOCK-TYPE BARRIER

(71) Applicant: AGRITUBEL, LOUDUN (FR)

(72) Inventor: Philippe DUBOUIX, LOUDUN (FR)

(21) Appl. No.: 18/299,137

(22) Filed: Apr. 12, 2023

(30) Foreign Application Priority Data
Apr. 14, 2022 (FR) 2203459

(51) Int. Cl. A01K 1/06

(52) U.S. Cl. CPC A01K 1/0606

(57) ABSTRACT

Disclosed is a swing-arm suitable for a headlock-type barrier, the swing-arm including: a tubular arm defining an axis of extension, the tubular arm being intended to pivot about a first transverse axis relative to a fixed base; and a return member adapted to ensure a return of the tubular arm to a first position about the first transverse axis, characterized in that the return member is arranged inside the tubular arm.

### TECHNICAL FIELD

This description relates to a swing-arm suitable for a headlock-type barrier. This description also relates to an assembly for a headlock-type barrier comprising such a swing-arm, and to a headlock-type barrier comprising such an assembly.

### PRIOR ART

Headlock-type barriers are used to manage animal feeding and also to immobilize an animal in order to carry out certain interventions, in particular veterinary care.

A headlock-type barrier generally comprises an upper pole, a lower pole, and a plurality of vertical uprights each extending between the upper pole and the lower pole so as to define a plurality of frames. Each frame is therefore delimited vertically by the upper pole and lower pole and longitudinally by two adjacent vertical uprights.

The longitudinal direction means the direction in which the upper pole and the lower pole extend. The vertical direction corresponds to the direction of the Earth's gravity field. The vertical direction is perpendicular to the longitudinal direction. Lastly, the transverse direction corresponds to a direction perpendicular to the longitudinal direction and to the vertical direction. Furthermore, absolute position qualifiers such as “top”, “bottom”, etc., or relative position qualifiers such as “above”, “below”, “upper”, “lower”, etc., and orientation qualifiers such as “vertical” and “horizontal”, are in reference to the vertical direction as defined.

Each frame is equipped with a swing-arm for restraining an animal. The swing-arm is movable from an open position allowing the passage of the animal's head. The swing-arm can be pivoted into a closed position defining a restricted passage which either allows denying access for an animal, or hobbling an animal by the neck. The swing-arm can also be pivoted into a release position allowing the animal to access a trough to feed. Means are conventionally provided for locking the swing-arm in one or more of these positions or in an intermediate position.

These barriers further include means suitable for ensuring the automatic return and the retention of the swing-arm in the open position. These means eliminate manual intervention to return the swing-arm to its open position. Thus, once the animal is released, the swing-arm automatically returns to the open position so it is once again ready for use.

Nevertheless, the known means for ensuring the return of the swing-arm to the open position are generally mounted in an exposed manner between a vertical upright and the swing-arm. Therefore, such means pose a risk of injury to the animal and/or the human operator. Moreover, these means are not protected and are therefore likely to be damaged.

In addition, these means are generally made of elastomer. Such materials are not entirely satisfactory in that their mechanical properties are sensitive to external conditions such as temperature or UV radiation, and in that they are not resistant to the aging phenomenon.

### SUMMARY OF THE INVENTION

This disclosure improves the situation.

According to a first aspect, a swing-arm suitable for a headlock-type barrier (also called, cattle stanchion barrier) is proposed, the swing-arm comprising:
a tubular arm defining an axis of extension, the tubular arm being intended to pivot about a first transverse axis relative to a fixed base;
a return member adapted to ensure a return of the tubular arm to a first position about the first transverse axis, characterized in that the return member is arranged inside the tubular arm.

The return member is thus protected from the external environment. This also makes it possible to avoid, or even prevent, blockage of the return member by a foreign body. Also, the service life of such a return member is improved. In addition, access to the return member is restricted, thus improving safety for the user and/or the animal.

The return member can be integrally (or entirely) arranged inside the tubular arm. In other words, not part of the tubular arm extend outside of the tubular arm.

The axis of extension of the tubular arm can be perpendicular to the first transverse axis. The swing-arm can in particular pivot between an open position allowing the passage of an animal's head in an upper part of the frame and a release position allowing the animal to access a trough to feed and/or to withdraw its head via a lower part of the frame. The first position about the first transverse axis can be the open position, the release position, or an intermediate position between the open position and the release position.

The swing-arm can comprise a shaft extending along the first transverse axis and on which the tubular arm is pivotally mounted, the shaft being intended to be rigidly fixed to the base. Such a shaft constitutes a reliable and economical solution for guiding the tubular arm in rotation about the first transverse axis relative to the base.

The tubular arm can have a first hole and a second hole arranged opposite one another in the transverse direction, the shaft extending transversely through the first hole and second hole. The shaft can comprise a first right circular cylindrical guide portion and a second right circular cylindrical guide portion. The first guide portion and the second guide portion can be respectively received, in whole or in part, in the first hole and the second hole through the tubular arm. The circular cross-section of the first guide portion and the circular cross-section of the second guide portion thus enable rotation of the tubular arm on the shaft, about the first transverse axis.

The return member can comprise a coil spring wound around the first transverse axis, the coil spring having a first end portion which is arranged, in whole or in part, to rest against an inner face of the tubular arm at a distance from the first transverse axis, and a second end portion which is mounted on the shaft to be integral in rotation about the first transverse axis. Such a spring allows a lighter swing-arm. In particular, such a spring makes it possible to avoid an arrangement with a weight acting as a counter-balance to return the swing-arm to the first position.

The second end portion of the coil spring can surround a central portion of the shaft. The second end portion of the coil spring and the central portion of the shaft can be associated by the complementarity of their shapes so as to block rotation about the first transverse axis between the second end portion of the coil spring and the central portion of the shaft. The tubular arm can have an opening arranged at least at one of its ends, the opening being configured to insert the return member inside the tubular arm. In the vicinity of the articulation of the tubular around the shaft, the first hole and the second hole in which extend the shaft can be the sole openings of the tubular arm, thus better protecting the return member from the external environment.

The central portion of the shaft can have a square cross-section, preferably with chamfered corners. A square cross-section allows blocking rotation of the second end portion of the coil spring about the first transverse axis, relative to the central portion of the shaft. The chamfers permit better cooperation between the shaft and the second end portion of the coil spring and thus limit wear of the coil spring. The central portion of the shaft can be arranged inside the tubular arm.

When the tubular arm is in the first position about the first transverse axis, the coil spring can have a minimal tension. This ensures an automatic return of the arm of the swing-arm to the first position about the first transverse axis when it is not in the first position about the first transverse axis and no force is being applied to the arm of the swing-arm. When the tubular arm is in the first position about the first transverse axis, the coil spring can have a pre-tension, i.e. a non-zero tension. This allows better return of the tubular arm to the first position about the transverse axis.

The first end portion of the coil spring extends generally in a rectilinear manner. This allows a greater lever effect between the first end portion of the coil spring and the inner face of the tubular arm, in order to optimize the action exerted by the tubular arm on the coil spring.

The swing-arm can comprise a stop mechanism adapted to limit movement of the return member inside the tubular arm, at least in the direction of the axis of extension of the tubular arm. The stop mechanism retains the return member inside the tubular arm, in particular during assembly or transport of the swing-arm.

The stop mechanism can comprise:
a first bearing that is fixed relative to the tubular arm, the first bearing comprising a tubular stem extending along the first transverse axis inside the tubular arm,
a cage arranged inside the tubular arm, in which the coil spring is, in part, received in a floating manner, the cage comprising a first relief cooperating with the stem of the first bearing in order to block movement of the cage inside the tubular arm in a first direction along the axis of extension of the tubular arm.

The coil spring can then be retained inside the tubular arm end before inserting the shaft through the tubular arm. In addition, the coil spring can be held inside the tubular arm with the second end portion of the coil spring centered around the first transverse axis, to allow the shaft to be inserted therein.

“Floating” is understood to mean that limited movement of the coil spring within the cage is permitted. The first direction along the axis of extension of the tubular arm can be oriented towards a lower end of the tubular arm. The stem of the first bearing can have the shape of a right circular cylinder around the first transverse axis. The first relief of the cage can have the shape of an arc of a circle around the first transverse axis. The first relief of the cage can cooperate with an outer face of the stem of the first bearing. The first end portion of the coil spring can extend outside the cage.

The stop mechanism can comprise a second bearing that is fixed relative to the tubular arm, the second bearing comprising a tubular stem extending along the first transverse axis inside the tubular arm, the cage comprising a second relief cooperating with the stem of the second bearing in order to block movement of the cage inside the tubular arm in at least a second direction along the axis of extension of the tubular arm.

The coil spring is therefore completely surrounded within the tubular arm in the direction of extension of the tubular arm, and its movement in the direction of extension of the tubular arm is limited to some play. In addition, the spring is held in the tubular arm in a configuration allowing direct assembly of the swing-arm on a headlock-type barrier, i.e. without it being necessary to perform additional operations of repositioning the coil spring inside the tubular arm. Furthermore, the swing-arm can be transported or handled with no risk of displacement of the coil spring inside the tubular arm or loss of the coil spring. However, some play between the return member and one of the stems or between the return member and each stem cannot be ruled out. The second direction along the axis of extension of the tubular arm can be oriented towards an upper end of the tubular arm. The second relief of the cage can cooperate with the stem of the second bearing in order to block movement of the cage inside the tubular arm in the first direction and in the second direction along the axis of extension of the tubular arm.

The stem of the second bearing can have the shape of a right circular cylinder around the first transverse axis. The second relief of the cage can have a circular shape around the first transverse axis. The second relief of the cage can cooperate with an outer face of the stem of the second bearing.

The cage can be adapted to receive the coil spring in a single direction of winding around the first transverse axis in which the coil spring exerts a return force on the tubular arm so as to pivot it in a direction of rotation about the first transverse axis towards the first position about the first transverse axis. This prevents a user from placing the coil spring in a configuration where the coil spring exerts an action tending to pivot the tubular arm in a direction of rotation about the first transverse axis that is opposite from the first position.

The cage can be interposed, in the transverse direction, between the stem of the first bearing and the stem of the second bearing in order to limit movement of the cage in the transverse direction.

The first bearing and the second bearing can be fixed to each other.

The stem of the first bearing and the stem of the second bearing can extend transversely through the first hole and the second hole respectively, all the way through the tubular arm so as to extend partly outside the tubular arm.

The first bearing and the second bearing can each comprise a flange, projecting from a portion of the respective stem, which is located outside the tubular arm, the tubular arm being clamped, in the transverse direction, between the flange of the first bearing and the flange of the second bearing. The first bearing and second bearing can each comprise a holding tab. The holding tab of each among the first bearing and second bearing can be integral with the respective flange. The holding tab of each among the first bearing and second bearing can be arranged outside the tubular arm. The holding tab of the first bearing and the holding tab of the second bearing can be facing one another in the transverse direction. The holding tab of the first bearing can be fixed to the holding tab of the second bearing, in particular by screwing.

The holding tab of the first bearing can rest against the holding tab of the second bearing, in the transverse direction. The holding tab of the first bearing and the holding tab of the second bearing may each comprise a boss. The holding tab of the first bearing and the holding tab of the second bearing can rest against each other, in the transverse direction, at their respective bosses. This makes it possible to apply the flange of each of the bearings in the transverse direction against the tubular arm so that the tubular arm is clamped transversely between the flange of each of the bearings.

The flange of the first bearing and the flange of the second bearing can each have a support face which rests against an outer face of the tubular arm, the support face of each flange defining a portion of a right circular cylinder. Thus, the support face of each flange has a shape adapted to fit against the outer face of the tubular arm. This makes it possible for the bearings to be more securely integral with the tubular arm.

The stem of the first bearing and the stem of the second bearing can respectively cover the first guide portion and the second guide portion of the shaft so that the tubular stem of the first bearing, respectively of the second bearing, is interposed between one of the holes through the tubular arm and the first guide portion, respectively the second guide portion. This makes it possible to limit or even avoid out-of-roundness or deformation of the first hole and second hole through the tubular arm.

The diameter of the stem of the first bearing can be different from the diameter of the stem of the second bearing. This prevents a user from reversing the first bearing and second bearing when assembling the swing-arm.

The return member can be made of metal. A metal return member offers the advantage of having mechanical properties which are less affected by external conditions such as temperature or ultraviolet radiation, and by the aging phenomenon, particularly in comparison with a plastic material such as rubber, for example.

An assembly for a headlock-type barrier is also proposed, the assembly comprising:
a swing-arm as described above;
a base intended to be fixed to, or formed by, a fixed element of a headlock-type barrier, the base comprising a first flange and a second flange spaced apart from each other in the transverse direction, the shaft being connected to the first flange and to the second flange;
and wherein the tubular arm is arranged between the first flange and the second flange, in the transverse direction.

The fact that the tubular arm of the swing-arm is arranged between the first flange and the second flange of the base makes it possible to limit, or even prevent, movement of the tubular arm in the transverse direction. Each flange can extend perpendicularly to the first transverse axis. The first flange and the second flange can respectively comprise a first hole and a second hole centered on the first transverse axis, the shaft extending through the hole of each flange. The diameter of the first hole through the first flange can be greater than the diameter of the second hole through the second flange. The diameter of the shaft's first guide portion can be greater than the diameter of the hole through the second flange. This ensures a single direction of insertion of the shaft through the tubular arm, first flange, and second flange.

The shaft can be fixed in rotation about the first axis transverse relative to the base, by the complementarity of shapes between a locking portion of the shaft and the base. The locking portion of the shaft can be received in the first hole through the first flange. The locking portion can have a cross-section adapted to cooperate with an inner face of the first hole through the first flange so that the shaft is integral in rotation with the first flange about the first transverse axis. The locking portion of the shaft can have a cross-section with an anti-rotation profile, for example a square, polygonal, oval cross-section, or a shape comprising at least one flat portion.

The shaft can comprise a head at a first end in the transverse direction, the head having a support surface which rests, in the transverse direction, against an outer face of the first flange. The outer face of the first flange can be opposite from the second flange in the transverse direction. When assembling the swing-arm, placing the head of the shaft to rest against the outer face of the first flange ensures correct positioning of the shaft in the transverse direction.

The shaft head can have an anti-rotation outer profile. This allows engaging the head of the shaft with a tool adapted to keep the shaft rotating about the first transverse axis and/or with a tool adapted to drive the shaft to rotate about the first transverse axis in order to generate pre-tension in the spring when assembling the assembly, thus allowing better return of the swing-arm to the first position about the first transverse axis. The pre-tension can be applied to the coil spring with the shaft arranged so that the locking portion of the shaft is not engaged with the inner face of the first hole through the first flange of the base.

The shaft can comprise a threaded portion at a second end in the transverse direction, the threaded portion extending from a side of the second flange that is opposite from the first flange in the transverse direction. The assembly can further comprise a nut screwed onto the threaded portion of the shaft in order to tighten it against an outer face of the second flange. The outer face of the second flange can be opposite from the first flange in the transverse direction.

The threaded portion of the shaft can extend transversely from the second end of the shaft to a portion of the shaft that is coincident with the outer face of the second flange. This makes it possible to avoid, or even prevent, excessive tightening of the nut which could deform the flanges.

The shaft can comprise a shoulder which rests, in the transverse direction, against an inner face of the second flange. The inner face of the second flange can be facing the first flange in the transverse direction. This allows maintaining the spacing between the first flange and the second flange in the transverse direction when tightening the nut. The flange of the first bearing, respectively of the second bearing, can be interposed between the tubular arm and the first flange, respectively the second flange. The flange of the first bearing allows maintaining a space between the tubular arm and the first flange of the base. Similarly, the flange of the second bearing allows maintaining a space between the tubular arm and the second flange of the base. This makes it possible to limit or even prevent the striking of the tubular arm against one and/or the other of the flanges. The noise emitted by the assembly during its use is thus reduced.

The first bearing and/or the second bearing can each be made of plastic. This makes it possible to reduce the noise produced during rotation of the tubular arm and the bearings relative to the flanges of the base. Also, this allows even better avoidance of the phenomenon of out-of-roundness of the first hole and second hole through the tubular arm.

A headlock-type barrier is also proposed, comprising:
an upper pole (or rail, or rod) and a lower pole (or rail, or rod) each extending in a longitudinal direction;
a first vertical upright and a second vertical upright each connected to the lower pole and to the upper pole so as to define a frame,
an assembly for a headlock barrier as described above,

and wherein the first flange and the second flange of the base are fixed to the frame.

The transverse direction can be perpendicular to the longitudinal direction. In other words, the first transverse axis can be normal to a plane of the barrier, i.e. a plane containing each of the longitudinal axes along which the upper pole and lower pole extend.

The first flange and the second flange can be secured to an angled bar which is fixed to the frame. The angled bar can extend inside the frame. The angled bar can be attached to the upper pole and the lower pole. Alternatively, the angled bar can be attached to the first vertical upright and to one among the upper pole and the lower pole.

According to a second aspect, independent of the first aspect, wherein the return function described above can be omitted, a swing-arm suitable for a headlock-type barrier is proposed, the swing-arm comprising:
a shaft extending along a first transverse axis and intended to be rigidly fixed to a base,
a tubular arm defining an axis of extension, the tubular arm being mounted on the shaft so as to pivot about the first transverse axis, the tubular arm having a first hole and a second hole which are arranged opposite one another along the first transverse axis, the shaft comprising a first guide portion and a second guide portion which are received respectively in the first hole and the second hole of the tubular arm so as to guide the tubular arm in rotation about the first transverse axis,
a first bearing and a second bearing which are fixed relative to the tubular arm, the first bearing and second bearing each comprising a tubular stem extending along the first transverse axis, the stem of the first bearing being interposed between the shaft's first guide portion and an inner face of the first hole through the tubular arm and the stem of the second bearing being interposed between the shaft's second guide portion and an inner face of the second hole through the tubular arm.

Such an arrangement makes it possible to avoid direct contact between the shaft and the inner face of each hole through the tubular arm. This allows limiting or even avoiding an out-of-roundness or deformation of the first hole and second hole through the tubular arm.

The first bearing and the second bearing can each comprise a flange projecting from a portion of their respective stem which is located outside the tubular arm, the tubular arm being clamped, in the transverse direction, between the flange of the first bearing and the flange of the second bearing. The first bearing and the second bearing can each comprise a holding tab integral with the respective flange. The holding tab of the first bearing and the holding tab of the second bearing can be arranged facing one another in the transverse direction. The holding tab of the first bearing can be fixed to the holding tab of the second bearing, in particular by screwing.

The swing-arm according to the second aspect can comprise one or more features, taken independently or in combination, of the swing-arm according to the first aspect as described above.

According to the second aspect, an assembly for a headlock-type barrier is also proposed, the assembly comprising:
a swing-arm as described above according to the second aspect;
a base intended to be fixed to, or formed by, an upright defining a frame of a headlock-type barrier, the base comprising a first flange and a second flange spaced apart from each other in the transverse direction, the shaft being connected to the first flange and to the second flange;

and wherein the tubular arm is arranged between the first flange and the second flange, in the transverse direction.

The assembly for a headlock-type barrier according to the second aspect may comprise one or more features, taken independently or in combination, of the assembly for a headlock-type barrier according to the first aspect as described above.

According to the second aspect, a headlock-type barrier is also proposed, comprising:
an upper pole and a lower pole each extending in a longitudinal direction;
a first vertical upright and a second vertical upright each connected to the lower pole and to the upper pole so as to define a frame,
an assembly for a headlock barrier according to the second aspect as described above,

and wherein the first flange and the second flange of the base are integral with the first vertical upright.

The headlock-type barrier according to the second aspect may comprise one or more features, taken independently or in combination, of the headlock-type barrier according to the first aspect as described above.

According to a third aspect, independent of the first aspect and the second aspect, a swing-arm is proposed comprising:
a tubular arm defining an axis of extension, the tubular arm being intended to pivot about a first transverse axis relative to a fixed base;
a return member adapted to return the tubular arm to a first position about the first transverse axis, the return member being arranged inside the tubular arm; and
a stop mechanism adapted to limit movement of the return member inside the tubular arm, at least in the direction of the axis of extension of the tubular arm.

The stop mechanism allows retaining the return member inside the tubular arm, in particular during assembly or transport of the swing-arm.

The stop mechanism can include:
a first bearing that is fixed relative to the tubular arm, the first bearing comprising a tubular stem extending along the first transverse axis inside the tubular arm,
a cage arranged inside the tubular arm, in which the return member is, in part, received in a floating manner, the cage comprising a first relief cooperating with the stem of the first bearing in order to block movement of the cage inside the tubular arm in a first direction along the axis of extension of the tubular arm.

“Floating” is understood to mean that limited movement of the return member within the cage is permitted. The first direction along the axis of extension of the tubular arm can be oriented towards an upper end of the tubular arm. The stem of the first bearing can have the shape of a right circular cylinder around the first transverse axis. The first relief of the cage can have the shape of an arc of a circle around the first transverse axis. The first relief of the cage can cooperate with an outer face of the stem of the first bearing.

The stop mechanism can comprise a second bearing that is fixed relative to the tubular arm, the second bearing comprising a tubular stem extending along the first transverse axis inside the tubular arm, the cage comprising a second relief cooperating with the stem of the second bearing in order to block movement of the cage inside the tubular arm in at least a second direction along the axis of extension of the tubular arm.

The return member is thus completely surrounded within the tubular arm in the direction of extension of the tubular arm, and its movement in the direction of extension of the tubular arm is limited to some play. The swing-arm can be transported or handled with no risk of displacement of the return member inside the tubular arm or loss of the return member. However, some play between the return member and one of the stems or between the return member and each stem cannot be ruled out. The second direction along the axis of extension of the tubular arm can be oriented towards a lower end of the tubular arm. The second relief of the cage can cooperate with the stem of the second bearing in order to block movement of the cage inside the tubular arm in the first direction and in the second direction along the axis of extension of the tubular arm.

The stem of the second bearing can have the shape of a right circular cylinder around the first transverse axis. The second relief of the cage can have a circular shape around the first transverse axis. The second relief of the cage can cooperate with an outer face of the stem of the second bearing.

The cage can be interposed, in the transverse direction, between the stem of the first bearing and the stem of the second bearing in order to limit movement of the cage in the transverse direction.

The cage can have a first side wall and a second side wall which are spaced apart from each other in the transverse direction. Due to the cooperation of the first relief and the second relief with the stem of the first bearing and the stem of the second bearing respectively, the cage can be arranged in the tubular arm with the first side wall and the second wall being arranged facing the first bearing and the second bearing with only one orientation possible in the transverse direction. In other words, the cage can be arranged with the first side wall arranged on the same side, in the transverse direction, as the first bearing relative to the axis of extension of the tubular arm, and with the second side wall arranged on the same side, in the transverse direction, as the second bearing relative to the axis of extension of the tubular arm.

The swing-arm according to the third aspect may comprise one or more features, taken independently or in combination, of the swing-arm according to the first aspect as described above.

### BRIEF DESCRIPTION OF DRAWINGS

Other features, details, and advantages will become apparent upon reading the detailed description below, and upon analyzing the appended drawings, in which:

FIG. 1 shows a partial schematic view of a headlock-type barrier according to the present description;

FIG. 2 is a view on a larger scale of the hinge of the swing-arm of the barrier of FIG. 1, and schematically represents the travel of the swing-arm;

FIG. 3 comprises FIG. 3a which schematically represents a section view of the swing-arm of FIG. 1 when it is in the open position, and FIG. 3b which schematically represents a section view of the swing-arm of FIG. 1 when it is in the release position;

FIG. 4 schematically represents the hinge of the swing-arm of FIG. 2 in section plane IV-IV;

FIG. 5 comprises FIG. 5a which schematically represents the hinge of the swing-arm of FIG. 2 in section plane V-V and FIG. 5b which is a view on a larger scale of the area encircled in FIGS. 5a;

FIG. 6 schematically represents the return member used in the hinge of FIGS. 4 and 5;

FIG. 7 comprises FIG. 7a and FIG. 7b which show a perspective view of a cage used in the hinge of FIGS. 4 and 5 and in which is housed the return member of FIG. 6;

FIG. 8 schematically represents the shaft used in the hinge of FIGS. 4 and 5;

FIG. 9 schematically represents the positioning of the return member of FIG. 6 inside the tubular arm of the swing-arm.

### DESCRIPTION OF THE INVENTION

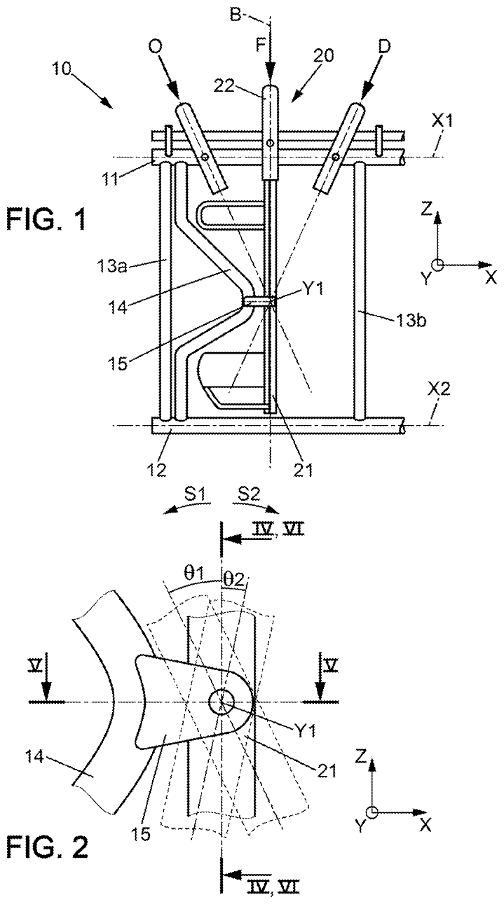

Reference is now made to FIGS. 1 to 3 which partially represent a headlock-type barrier 10. Barrier 10 firstly comprises an upper pole 11 and a lower pole 12 each extending along a longitudinal direction X. Upper pole 11 extends along a first longitudinal axis X1 and lower pole 12 extends along a second longitudinal axis X2. First longitudinal axis X1 and second longitudinal axis X2 define a plane of barrier 10.

As above, in the following description the longitudinal direction X means the direction in which upper pole 11 and lower pole 12 extend. The vertical direction Z corresponds to the direction of the Earth's gravity field. The vertical direction Z is perpendicular to the longitudinal direction X. Finally, the transverse direction Y corresponds to a direction perpendicular to the longitudinal direction X and to the vertical direction Z. In addition, absolute position qualifiers such as the terms “top”, “bottom”, etc., or relative position qualifiers such as the terms “above”, “below”, “upper”, “lower”, etc., and orientation qualifiers such as the terms “vertical” and “horizontal”, are in reference to the vertical direction Z as defined, and unless otherwise specified, to the orientation of the figures.

Barrier 10 comprises a first vertical upright 13a and a second vertical upright 13b each extending in vertical direction Z. Vertical uprights 13a, 13b are each connected to lower pole 12 and to upper pole 11. Lower pole 12, upper pole 11, and the pair of vertical uprights 13a, 13b thus define a frame. Barrier 10 further comprises an angled bar 14 extending within the plane of barrier 10, inside the frame. Angled bar 14 is fixed relative to the frame. A lower end of angled bar 14 here is connected to lower pole 12 and an upper end of angled bar 14 is connected to upper pole 11.

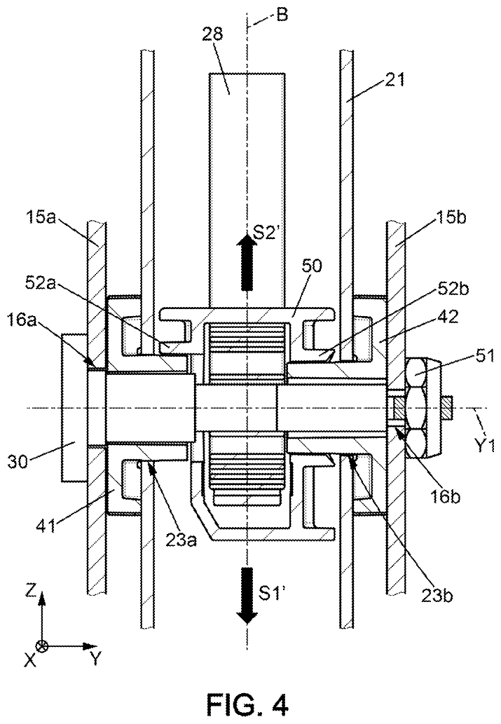

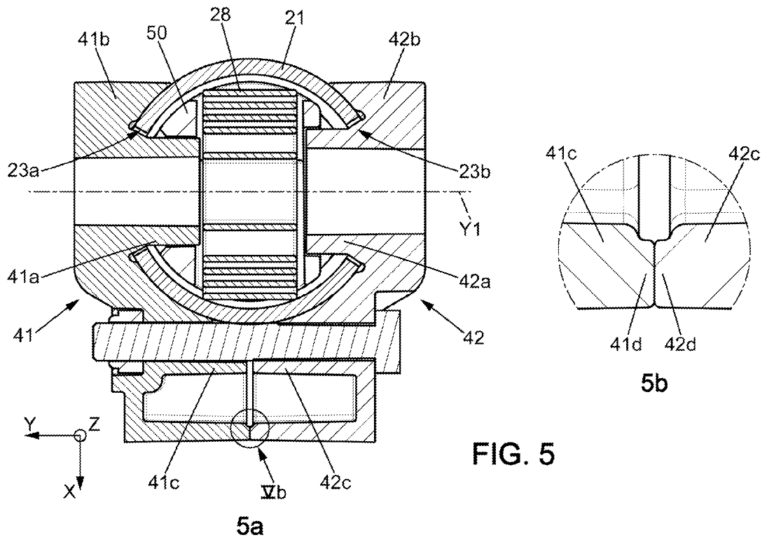

Barrier 10 also comprises a swing-arm 20. Swing-arm 20 includes a tubular arm 21 defining an axis of extension B. Axis of extension B of tubular arm 21 here is contained within the plane of barrier 10. In other words, axis of extension B of tubular arm 21 is perpendicular to transverse direction Y. Swing-arm 20 is hinged to pivot about a first transverse axis Y1 relative to a base 15 which is integral with angled bar 14. The hinging of tubular arm 21 relative to base 15 is shown in more detail in FIGS. 4 and 5.

Base 15 here comprises a first flange 15a and a second flange 15b which are integral with angled bar 14. First flange 15a and second flange 15b are spaced from each other in transverse direction Y. Each flange 15a, 15b extends perpendicularly to first transverse axis Y1. Tubular arm 21 is arranged, in transverse direction Y, between first flange 15a and second flange 15b. Movement of tubular arm 21 in transverse direction Y is thus limited or even prevented.

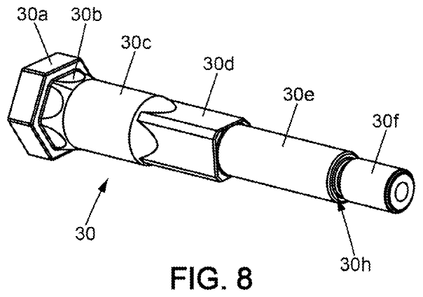

Swing-arm 20 comprises a shaft 30 extending along first transverse axis Y1 and about which tubular arm 21 pivots. Shaft 30 is rigidly connected to first flange 15a and to second flange 15b. Shaft 30 is more particularly visible in FIGS. 4 and 8. Such a shaft 30 constitutes a reliable and economical solution for guiding tubular arm 21 in rotation about first transverse axis Y1, relative to base 15.

To ensure rotational guidance of tubular arm 21 about first transverse axis Y1, tubular arm 21 has a first hole 23a and a second hole 23b which are arranged opposite one another in transverse direction Y and through which shaft 30 extends. For this purpose, shaft 30 comprises a first guide portion 30c and a second guide portion 30e, each being a right circular cylinder about first transverse axis Y1. First guide portion 30c and second guide portion 30e are respectively received, in part, in first hole 23a and second hole 23b through tubular arm 21.

To attach shaft 30 to base 15, first flange 15a and second flange 15b respectively comprise a first hole 16a and a second hole 16b which are centered on first transverse axis Y1. Shaft 30 extends through holes 16a, 16b formed in flanges 15a, 15b. It is noteworthy that the diameter of first hole 16a through first flange 15a is greater than the diameter of second hole 16b through second flange 15b. Furthermore, the diameter of first guide portion 30c of shaft 30 is greater than the diameter of second hole 16b through second flange 15b. This ensures a single direction of insertion of shaft 30 through tubular arm 21.

Shaft 30 also comprises a head 30a at a first end in transverse direction Y. Head 30a has a support surface which rests, in transverse direction Y, against an outer face of first flange 15a. The outer face of first flange 15a is opposite from second flange 15b in transverse direction Y. During assembly of swing-arm 20, the bearing of head 30a of shaft 30 against the outer face of first flange 15a ensures the correct positioning of shaft 30 in the transverse direction Y. As can be seen in FIG. 8, head 30a of shaft 30 has an external profile of polygonal shape, here hexagonal. This allows engaging head 30a of shaft 30 with a tool adapted to keep shaft 30 rotating about first transverse axis Y1 or with a tool adapted to drive shaft 30 to rotate about first transverse axis Y1. Alternatively, the external profile of the head can have any shape suitable for engaging with the tool.

Shaft 30 further comprises a threaded portion 30f at a second end in transverse direction Y. Threaded portion 30f extends from a side of second flange 15b which is opposite from first flange 15a in transverse direction Y. A nut 31, preferably a lock nut, is screwed onto threaded portion 30f of shaft 30 to be tightened against an outer face of second flange 15b. The outer face of second flange 15b is opposite from first flange 15a in transverse direction Y. Optionally, when head 30a of shaft 30 rests against the outer face of first flange 15a, it may also be provided that threaded portion 30f of shaft 30 extends transversely from the second end of the shaft to a portion of the shaft which is aligned transversely with the outer face of second flange 15b. This makes it possible to avoid, or even prevent, excessive tightening of nut 31, which could deform flanges 15a, 15b. Again optionally, shaft 30 can also comprise a shoulder 30h which rests, in transverse direction Y, against an inner face of second flange 15b. The inner face of second flange 15b is transversely opposite the outer face and is therefore facing first flange 15a in transverse direction Y. This allows maintaining the spacing between first flange 15a and second flange 15b in transverse direction Y when tightening nut 31. Alternatively, provision may be made for tightening to a predetermined torque between shaft 30 and nut 31 in order to avoid deformation of flanges 15a, 15b.

Furthermore, shaft 30 is kept fixed in rotation about first transverse axis Y1 relative to base 15, by the complementarity of shapes between a locking portion 30b of shaft 30 and first hole 16a through first flange 15a. Locking portion 30b of shaft 30 is received in first hole 16a through first flange 15a. Locking portion 30b has a cross-section adapted to cooperate with an inner face of first hole 16a through first flange 15a so as to make shaft 30 integral in rotation with first flange 15a, about first transverse axis Y1. As can be seen in FIG. 8, locking portion 30b of shaft 30 has a shape comprising flat portions.

As shown in FIG. 1, swing-arm 20 can pivot between an open position O allowing the passage of an animal's head in an upper part of the frame, and a release position D allowing the animal to access a trough to feed and/or to withdraw its head via a lower part of the frame. In other words, in open position O, swing-arm 20 is in a position such that a lower portion of the arm of swing-arm 20 obstructs the lower part of the frame. The passage of an animal's head through the frame is then only permitted in the upper part of the frame, longitudinally between an upper portion of the arm of swing-arm 20 and second vertical upright 13b. In release position D, swing-arm 20 is in a position such that an upper portion of the arm of swing-arm 20 obstructs the upper part of the frame. The passage of an animal's head through the frame is then only permitted at the lower part of the frame, longitudinally between a lower portion of the arm of swing-arm 20 and the second vertical upright 13b.

As shown in FIG. 2, in open position O, tubular arm 21 is pivoted by an angle θ1 in a first direction S1 about first transverse axis Y1. In open position O, tubular arm 21 abuts against an upper part of angled bar 14. Thus, the pivoting of tubular arm 21 beyond open position O in first direction S1 about first transverse axis Y1 is restricted. Open position O constitutes a first stopping position of tubular arm 21. In release position D, tubular arm 21 is pivoted by an angle θ2 in a second direction S2 about first transverse axis Y1. In release position D, tubular arm 21 is in abutment against a lower portion of angled bar 14. Thus, the pivoting of tubular arm 21 beyond release position D in second direction S2 about first transverse axis Y1 is restricted. Release position D constitutes a second stopping position of tubular arm 21.

Provision may further be made to be able to lock swing-arm 20 in a closed position F, which allows either denying an animal access through the frame, or hobbling the animal by the neck. For this purpose, swing-arm 20 comprises a fork 22 integral to an upper end of tubular arm 21 which is intended to cooperate with a locking mechanism. In the locking position, here the arm of swing-arm 20 extends in vertical direction Z.

Swing-arm 20 also comprises a return member adapted to ensure a return of tubular arm 21 to open position O. The return member here is housed in tubular arm 21. The return member is thus protected from the external environment. This makes it possible to avoid, or even prevent, blockage of the return member by a foreign body. Also, the service life of such a return member is improved. Furthermore, access to the return member is limited, thus improving safety for a user and/or an animal.

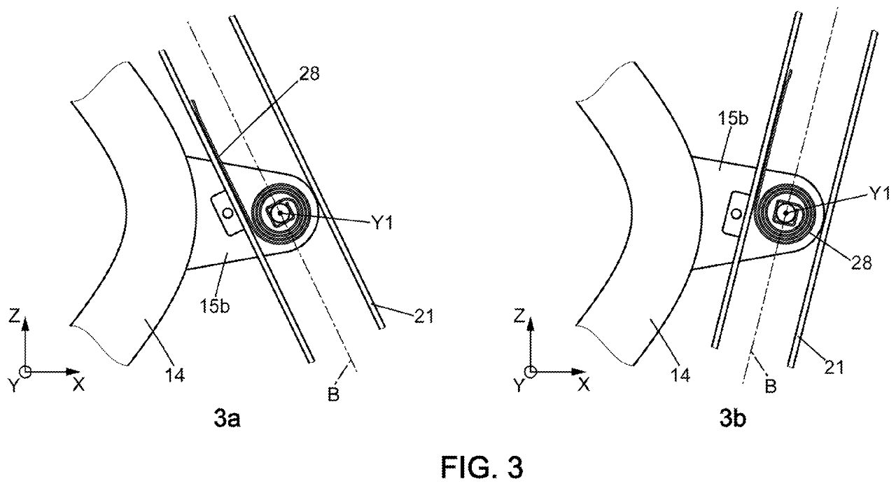

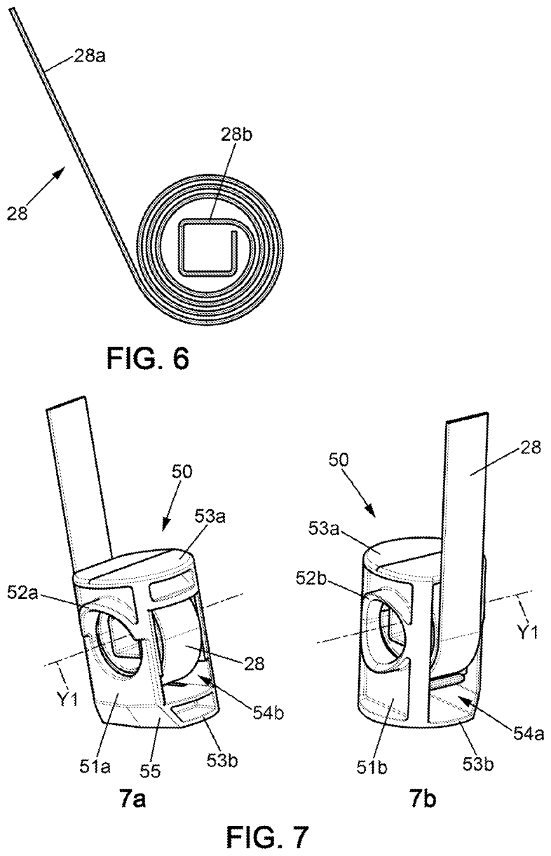

As shown in FIGS. 3 to 6, the return member comprises a coil spring 28 wound around first transverse axis Y1. The coil spring 28 is here flat. Coil spring 28 has a first end portion 28a of coil spring 28 which is arranged, at least in part, to rest against an inner face of tubular arm 21 at a distance from first transverse axis Y1, and a second end portion 28b which is mounted on shaft 30, fixed in rotation about first transverse axis Y1. Referring to FIG. 3a, when tubular arm 21 is in open position O about first transverse axis Y1, coil spring 28 can have a minimal tension. When tubular arm 21 is pivoted in second direction S2 about first transverse axis Y1, i.e. towards release position D represented in FIG. 3b, the spring is compressed by the action of tubular arm 21 on first end portion 28a of coil spring 28. An automatic return of the arm of the swing-arm to open position O about first transverse axis Y1 is ensured when it is not in open position O, and when no force, in particular rotational about first transverse axis Y1, is being applied to tubular arm 21. Moreover, such a spring makes it possible to avoid having a weight acting as a counter-balance and thus lightens swing-arm 20. In addition, first end portion 28a of coil spring 28 in general extends rectilinearly. This allows a greater lever effect between the first portion of coil spring 28 and an inner face of tubular arm 21, in order to optimize the action exerted by tubular arm 21 on coil spring 28.

Second end portion 28b of coil spring 28 surrounds a central portion 30d of shaft 30 which is arranged inside tubular arm 21. Second end portion 28b of coil spring 28 and central portion 30d of shaft 30 are associated by the complementarity of their shapes in order to ensure that rotation is blocked, between second end portion 28b of coil spring 28 and central portion 30d of shaft 30, about first transverse axis Y1. To achieve this, central portion 30d of shaft 30 has a square cross-section in the example shown. The square cross-section of central portion 30d of shaft 30 advantageously has chamfers enabling better cooperation between shaft 30 and second end portion 28b of coil spring 28 and thus limiting wear of coil spring 28.

When tubular arm 21 is in open position O about first transverse axis Y1, coil spring 28 can have a pre-tension, i.e. a non-zero tension. This allows better return of tubular arm 21 to open position O about the transverse axis. The pre-tension can be applied to coil spring 28 with shaft 30 arranged so that locking portion 30b of shaft 30 is not engaged with the inner face of first hole 16a through first flange 15a of base 15. Shaft 30 can be driven to rotate about first transverse axis Y1 by a tool adapted to be engaged on head 30a of the shaft in order to generate the pre-tension in the coil spring 28, during assembly of swing-arm 20.

Coil spring 28 can be made of metal. A metal coil spring 28 offers the advantage of having mechanical properties which are less affected by external conditions such as temperature or ultraviolet radiation, and by the aging phenomenon, in particular in comparison to a plastic material such as rubber, for example.

Swing-arm 20 also comprises a stop mechanism adapted to limit movement of the return member inside tubular arm 21. The stop mechanism retains the return member inside tubular arm 21, in particular during assembly or transport of swing-arm 20.

The stop mechanism firstly comprises a cage 50 arranged inside the tubular arm 21, in which the coil spring 28 is, in part, received in a floating manner. In particular, first end portion 28a of the spring is arranged outside cage 50. Cage 50 comprises a first side wall 51a and a second side wall 51b which are spaced apart from each other in transverse direction Y. First side wall 51a and second side wall 51b of cage 50 each have a hole centered on first transverse axis Y1 and adapted for the passage of shaft 30. Cage 50 also comprises a first relief 52a projecting from first side wall 51a in transverse direction Y towards the outside of cage 50, and a second relief 52b projecting from second side wall 51b in transverse direction Y towards the outside of cage 50. First relief 52a of cage 50 has the shape of an arc of a circle about first transverse axis Y1. Second relief 52b of cage 50 has a circular shape about first transverse axis Y1.

The cage further comprises an upper wall 53a and a lower wall 53b respectively arranged at an upper end and a lower end of cage 50. Cage 50 further comprises a first opening 54a and a second opening 54b spaced apart from each other in the longitudinal direction. Each opening 54a, 54b is delimited, in the transverse direction, between first side wall 51a and second side wall 51b. Each opening 54a, 54b is delimited, in the direction of axis of extension B of tubular arm 21, by upper wall 53a and lower wall 53b. It is noteworthy that in FIG. 7, only first opening 54a allows insertion of coil spring 28 inside cage 50.

The stop mechanism further comprises a first bearing 41 and a second bearing 42. First bearing 41 and second bearing 42 are fixed relative to tubular arm 21. First bearing 41 and second each comprise a tubular stem 41a, 42a whose axis is first transverse axis Y1. Tubular stem 41a, 42a of each bearing 41, 42 here is a right circular cylinder around first transverse axis Y1. Tubular stem 41a of first bearing 41 and tubular stem 42a extend inside tubular arm 21 on each side of cage 50. First relief 52a cooperates with an outer face of stem 41a of first bearing 41 in order to block movement of cage 50 inside tubular arm 21 in a first direction S1′ along axis of extension B of tubular arm 21. First direction S1′ along axis of extension B of tubular arm 21 is here directed towards the lower end of tubular arm 21. Second relief 52b cooperates with an outer face of stem 42a of second bearing 42 in order to block movement of cage 50 inside tubular arm 21 in first direction S1′ and in a second direction S2′ along axis of extension B of tubular arm 21. Second direction S2′ along axis of extension B of tubular arm 21 is here directed towards the upper end of tubular arm 21. In the example, second relief 52b surrounds stem 42a of second bearing 42. Cage 50 is also interposed, in transverse direction Y, between stem 41a of first bearing 41 and stem 42a of second bearing 42. Thus movement of cage 50 in the transverse direction Y is limited.

Coil spring 28 is therefore completely surrounded within tubular arm 21 in the direction of extension of tubular arm 21, and its movement in the direction of extension of tubular arm 21 is limited to some play. In addition, coil spring 28 is held in tubular arm 21 in a configuration allowing direct assembly of swing-arm 20 on a headlock-type barrier 10, i.e. without it being necessary to carry out additional operations of repositioning coil spring 28 inside tubular arm 21. Moreover, swing-arm 20 can be transported or handled with no risk of displacement of coil spring 28 inside tubular arm 21 or of loss of coil spring 28. However, play between coil spring 28 and one of the stems 41a, 42a or between coil spring 28 and each stem 41a, 42a is not excluded.

In order to fix first bearing 41 and second bearing 42 to tubular arm 21, stem 41a of first bearing 41 and stem 42a of second bearing 42 respectively extend transversely through first hole 23a and second hole 23b through tubular arm 21 so as to extend partly outside tubular arm 21. First bearing 41 and second bearing 42 each comprise a flange 41b, 42b projecting from a portion of the respective stem 41a, 42a which is located outside tubular arm 21, tubular arm 21 then being clamped, in transverse direction Y, between flange 41b of first bearing 41 and flange 42b of second bearing 42. Flange 41b of first bearing 41 and flange 42b of second bearing 42 each have a support face which rests against an outer face of tubular arm 21. The support face of each flange 41b, 42b defines a portion of a right circular cylinder. Thus, the support face of each flange 41b, 42b has a shape adapted to fit with the outer face of tubular arm 21. This allows better securing of bearings 41, 42 on tubular arm 21.

In the example, flange 41b of first bearing 41 is interposed in the transverse direction between first flange 15a of base 15 and tubular arm 21. Similarly, flange 42b of second bearing 42 is interposed in the transverse direction between second flange 15b of base 15 and tubular arm 21. Flange 41b of first bearing 41 allows maintaining a space between tubular arm 21 and first flange 15a of base 15, and flange 42b of second bearing 42 allows maintaining a space between tubular arm 21 and second flange 15b of base 15. This makes it possible to limit or even prevent the striking of tubular arm 21 against one and/or the other of flanges 15a, 15b. The noise emitted by the assembly during its use is thus reduced. Such an arrangement also allows reducing play in the transverse direction between tubular arm 21 and each of flanges 15a, 15b of base 15, which makes it possible to ensure the centering, in the transverse direction, of upper pole 11 between a pair of prongs of fork 22.

First bearing 41 and second bearing 42 are moreover fixed to each other. First bearing 41 and second bearing 42 each comprise a holding tab 41c, 42c integral to the respective flange 41b, 42b. Holding tab 41c of first bearing 41 and holding tab 42c of second bearing 42 face each other in transverse direction Y. Holding tab 41c of first bearing 41 is fixed to holding tab 42c of second bearing 42, here by screwing.

In addition, as shown in FIG. 5a, holding tab 41c of first bearing 41 is resting, in the transverse direction Y, against holding tab 42c of second bearing 42. As is more particularly visible in FIG. 5b, holding tab 41c of first bearing 41 and holding tab 42c of second bearing 42 each comprise a respective boss 41d, 42d. Holding tab 41c of first bearing 41 and holding tab 42c of second bearing 42 rest against each other, in the transverse direction, at their respective bosses 41d, 42d. This makes it possible to apply flange 41b, 42b of each of bearings 41, 42 in the transverse direction Y on the tubular arm so that tubular arm 21 is clamped transversely between flange 41b, 42b of each of bearings 41, 42.

It is noteworthy that stem 41a of first bearing 41 and stem 42a of second bearing 42 respectively cover first guide portion 30c and second guide portion 30e of shaft 30. Stem 41a of first bearing 41 is therefore interposed between an inner face of first hole 23a through tubular arm 21, and first guide portion 30c. Similarly, stem 41a of second bearing 42 is interposed between an inner face of second hole 23b through tubular arm 21, and second guide portion 30e. This makes it possible to limit or even avoid out-of-roundness or deformation of first hole 23a and of second hole 23b through tubular arm 21.

First bearing 41 and second bearing 42 can each be made of plastic. This makes it possible to reduce the noise produced during rotation of tubular arm 21 and bearings 41, 42 relative to flanges 15a, 15b of base 15. Also, this further reduces out-of-roundness of first hole 23a and of second hole 23b through tubular arm 21.

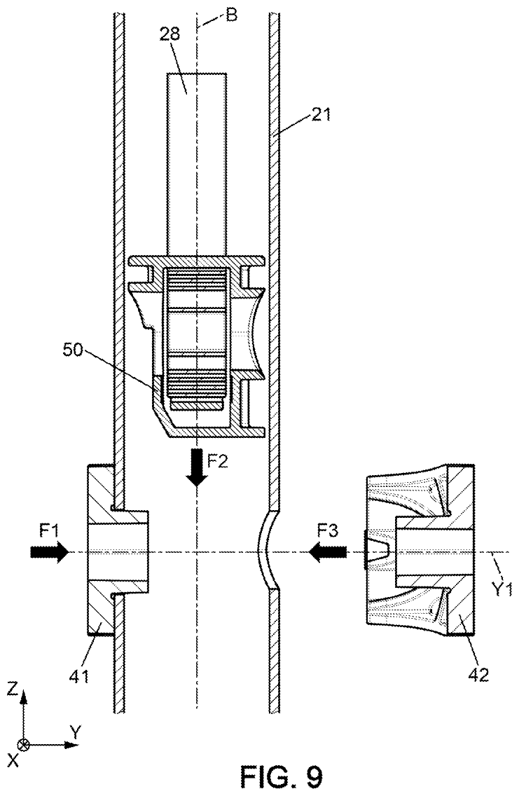

FIG. 9 schematically represents the assembling of cage 50 containing coil spring 28 inside tubular arm 21 by means of first bearing 41 and second bearing 42.

First bearing 41 is moved, as illustrated by arrow F1, relative to tubular arm 21 in transverse direction Y, so as to partially insert stem 41a of first bearing 41 into tubular arm 21 via first hole 23a through tubular arm 21. Stem 41a of first bearing 41 is inserted into tubular arm 21 until the support face of flange 41b of first bearing 41 is resting against tubular arm 21.

Cage 50 containing coil spring 28 is then moved, as illustrated by arrow F2, inside tubular arm 21 in the direction of axis of extension B of tubular arm 21 until first relief 52a of cage 50 is in abutment against stem 41a of first bearing 41.

The cage may include a chamfer where first side wall 51a and bottom wall 53b meet. Such a chamfer allows ensuring the passage of a portion of cage 50 between stem 41a of first bearing 41 and an inner face of tubular arm 21, until first relief 52a of cage 50 is in abutment against stem 41a of first bearing 41.

Finally, second bearing 42 is moved, as illustrated by arrow F3, relative to tubular arm 21 in transverse direction Y, so as to partially insert stem 42a of second bearing 42 into tubular arm 21 via second hole 23b through tubular arm 21. Stem 42a of second bearing 42 is inserted into tubular arm 21 until support face of flange 42b of second bearing 42 is resting against tubular arm 21 and until second relief 52b of cage 50 is cooperating with stem 42a of second bearing 42.

The diameter of stem 41a of first bearing 41 here is different from the diameter of stem 42a of second bearing 42. This prevents an operator from reversing first bearing 41 and second bearing 42 when assembling swing-arm 20.

Due to the cooperation of first relief 52a and second relief 52b respectively with stem 41a of first bearing 41 and stem 42a of second bearing 42, cage 50 is arranged in tubular arm 21 with first side wall 51a and second wall 51b being arranged facing first bearing 41 and second bearing 42 with only one orientation possible in the transverse direction. In other words, the cage is arranged with first side wall 51a arranged on the same side, in the transverse direction, as first bearing 41 relative to axis of extension B of tubular arm 21, and with second side wall 51b arranged on the same side, in the transverse direction, as second bearing 42 relative to axis of extension B of tubular arm 21.

Also, cage 50 is adapted to receive coil spring 28 solely in a configuration where coil spring 28 exerts a return force on tubular arm 21 so as to pivot the latter in a direction of rotation about first transverse axis Y1 to the open position. In other words, the cage is adapted to receive coil spring 28 in a single direction of winding about first transverse axis Y1, in which coil spring 28 exerts a return force on tubular arm 21 to pivot the latter in a direction of rotation about first transverse axis Y1 towards the open position.

1. Swing-arm suitable for a headlock-type barrier, the swing-arm comprising:
a. a tubular arm defining an axis of extension, the tubular arm being intended to pivot about a first transverse axis relative to a fixed base;
b. a return member adapted to ensure a return of the tubular arm to a first position about the first transverse axis, that wherein the return member is arranged inside the tubular arm.

2. The swing-arm according to claim 1, the swing-arm comprising a shaft extending along the first transverse axis and on which the tubular arm is pivotally mounted, the shaft being intended to be fixed rigidly to the base.

3. The swing-arm according to claim 2, wherein the return member comprises a coil spring wound around the first transverse axis, the coil spring having a first end portion which is arranged, in whole or in part, to rest against an inner face of the tubular arm at a distance from the first transverse axis, and a second end portion which is mounted on the shaft to be fixed in rotation about the first transverse axis.

4. The swing-arm according to claim 3, wherein the first end portion of the coil spring extends generally in a rectilinear manner.

5. The swing-arm according to claim 1, the swing-arm comprising a stop mechanism adapted to limit movement of the return member inside the tubular arm, at least in the direction of the axis of extension of the tubular arm.

6. The swing-arm according to claim 5, wherein the return member comprises a coil spring wound around the first transverse axis, the coil spring having a first end portion which is arranged, in whole or in part, to rest against an inner face of the tubular arm at a distance from the first transverse axis, and a second end portion which is mounted on the shaft to be fixed in rotation about the first transverse axis, and wherein the stop mechanism comprises:
a. a first bearing that is fixed relative to the tubular arm, the first bearing comprising a tubular stem extending along the first transverse axis inside the tubular arm,
b. a cage arranged inside the tubular arm, in which the coil spring is, in part, received in a floating manner, the cage comprising a first relief cooperating with the stem of the first bearing in order to block movement of the cage inside the tubular arm in a first direction along the axis of extension of the tubular arm.

7. The swing-arm according to claim 6, wherein the stop mechanism comprises a second bearing that is fixed relative to the tubular arm, the second bearing comprising a tubular stem extending along the first transverse axis inside the tubular arm, the cage comprising a second relief cooperating with the stem of the second bearing in order to block movement of the cage inside the tubular arm in at least a second direction along the axis of extension of the tubular arm.

8. The swing-arm according to claim 6, wherein the cage is adapted to receive the coil spring in a single direction of winding around the first transverse axis in which the coil spring exerts a return force on the tubular arm so as to pivot the tubular arm in a direction of rotation about the first transverse axis towards the first position about the first transverse axis.

9. The swing-arm according to claim 6, wherein each among the first bearing and the second bearing comprises a respective flange projecting from a portion of the respective stem, said flange being located outside the tubular arm, the tubular arm being clamped, in the transverse direction, between the flange of the first bearing and the flange of the second bearing.

10. The swing-arm according to claim 9, wherein each among the first bearing and second bearing comprises a respective holding tab arranged outside the tubular arm, the holding tab of the first bearing being fixed to the holding tab of the second bearing.

11. The swing-arm according to claim 10, wherein the holding tab of the first bearing and the holding tab of the second bearing each comprise a respective boss which is where said tabs rest against each other in the transverse direction.

12. The swing-arm according to claim 1, wherein the return member is made of metal.

13. Assembly for a headlock-type barrier, the assembly comprising:
a. a swing-arm according to claim 1;
b. a base intended to be fixed to, or formed by, a fixed element of a headlock-type barrier, the base comprising a first flange and a second flange spaced apart from each other in the transverse direction, the shaft being connected to the first flange and to the second flange;
and wherein the tubular arm is arranged between the first flange and the second flange, in the transverse direction.

14. Headlock-type barrier comprising:
an upper pole and a lower pole each extending in a longitudinal direction;
a first vertical upright and a second vertical upright each connected to the lower pole and to the upper pole so as to define a frame,
an assembly for a headlock barrier according to claim 13,
and wherein the first flange and the second flange of the base are fixed to the frame.
